(19) United States
(12) Patent Application Publication
(10) Pub. No.: US 2025/0261800 A1
(43) Pub. Date: Aug. 21, 2025

(54) KITCHEN STAND MIXER AND SHAFT HEIGHT ADJUSTMENT MECHANISM FOR A KITCHEN STAND MIXER

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/583,451

(22) Filed: Feb. 21, 2024

(51) Int. Cl. A47J 43/044; A47J 43/08

(52) U.S. Cl. CPC A47J 43/044; A47J 43/082; A47J 2043/04472; A47J 2043/0449

(57) ABSTRACT

A stand mixer includes a casing including a base, a column extending from the base, and a motor housing connected to the column; a motor assembly provided within the motor housing and including a motor shaft; and a shaft adjustment assembly operably coupled with the motor shaft, the shaft adjustment assembly including an output shaft connected with the motor shaft, the output shaft configured to receive a rotational input from the motor shaft, the output shaft including an attachment holder at a distal end thereof; a handle adjustably coupled with the output shaft, the handle being configured to be rotatable about the circumferential direction; and a resilient member connecting the handle with the output shaft, the resilient member biasing the handle along the axial direction and along the circumferential direction.

### FIELD OF THE INVENTION

The present subject matter relates generally to domestic appliances, and more particularly to shaft adjustment mechanisms for stand mixers.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. In performing operations, multiple different utensils may be frequently switched. Each utensil may be a different height, resulting in different depth to which each utensil may extend within a bowl, for example.

Existing mixers exhibit certain drawbacks. For instance, adjusting a height (or depth) of a particular utensil is cumbersome and time consuming. Additional accessories or manipulation of the mixer can be required in order to achieve a desired depth of the utensil.

Accordingly, a stand mixer that obviates one or more of the above-mentioned drawbacks would be beneficial. In particular, a shaft adjustment assembly for a stand mixer capable of fine tuning would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a stand mixer is provided. The stand mixer may include a casing including a base, a column extending from the base, and a motor housing connected to the column; a motor assembly provided within the motor housing, the motor assembly including a motor shaft; and a shaft adjustment assembly operably coupled with the motor shaft, the shaft adjustment assembly defining an axial direction, a radial direction, and a circumferential direction. The shaft adjustment assembly may include an output shaft connected with the motor shaft, the output shaft configured to receive a rotational input from the motor shaft, the output shaft including an attachment holder at a distal end thereof; a handle adjustably coupled with the output shaft, the handle being configured to be rotatable about the circumferential direction; and a resilient member connecting the handle with the output shaft, the resilient member biasing the handle along the axial direction and along the circumferential direction.

In another exemplary aspect of the present disclosure, a shaft adjustment assembly for a domestic appliance is provided. The domestic appliance may include a motor assembly and a motor shaft, the shaft adjustment assembly defining an axial direction, a radial direction, and a circumferential direction. The shaft adjustment assembly may include an output shaft connected with the motor shaft, the output shaft configured to receive a rotational input from the motor shaft, the output shaft including an attachment holder at a distal end thereof; a handle adjustably coupled with the output shaft, the handle being configured to be rotatable about the circumferential direction; and a resilient member connecting the handle with the output shaft, the resilient member biasing the handle along the axial direction and along the circumferential direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to an exemplary embodiment of the present disclosure.

FIG. 2 provides a front view of the exemplary stand mixer of FIG. 1.

FIG. 3 provides a close-up perspective view of a shaft adjustment assembly of the stand mixer of FIG. 1 according to exemplary embodiments of the disclosure with a handle in a first position.

FIG. 4 provides a close-up view of an output shaft of the exemplary shaft adjustment assembly of FIG. 3.

FIG. 5 provides a close-up section view of the exemplary output shaft of FIG. 4.

FIG. 6 provides a close-up perspective view of the exemplary shaft adjustment assembly of FIG. 3 including the handle.

FIG. 7 provides a close-up perspective view of the exemplary shaft adjustment assembly of FIG. 3 with an attachment in a detached position and the handle in a second position.

FIG. 8 provides a close-up perspective view of the output shaft of FIG. 4 with an attachment in a detached position.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

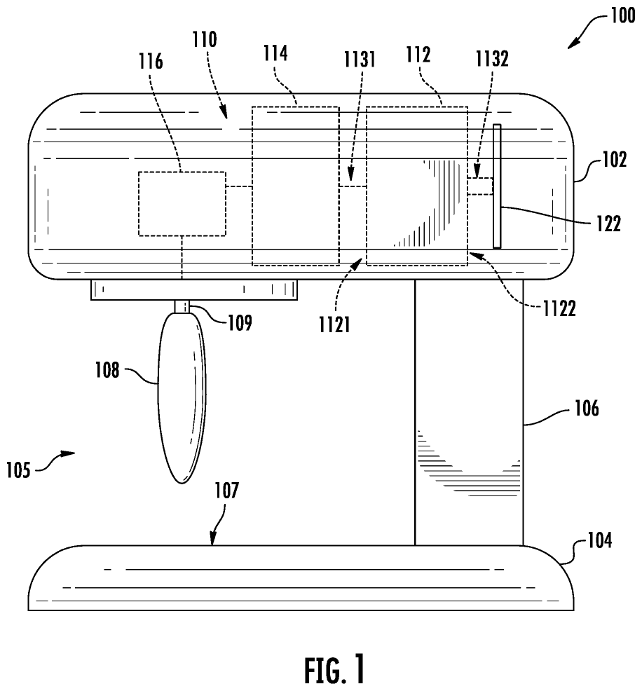

FIG. 1 provides a side view of a stand mixer 100 according to an exemplary embodiment of the present subject matter. It will be understood that stand mixer 100 is provided by way of example only and that the present subject matter may be used in or with any suitable stand mixer in alternative example embodiments. Moreover, with reference to FIG. 1, stand mixer 100 defines a vertical direction V, a lateral direction L, and a transverse direction T. It should be understood that these directions are presented for exemplary purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100. For example, as shown in FIG. 1, a motor 112, a planetary gearbox (or reduction gearbox) 114, and a bevel gear box 116 may be disposed within motor housing 102. Base 104 may support motor housing 102. For example, motor housing 102 may be mounted (e.g., pivotally) to base 104 via column 106, e.g., that extends upwardly (e.g., along the vertical direction V). Motor housing 102 may be suspended over a mixing zone 105, within which a mixing bowl may be disposed.

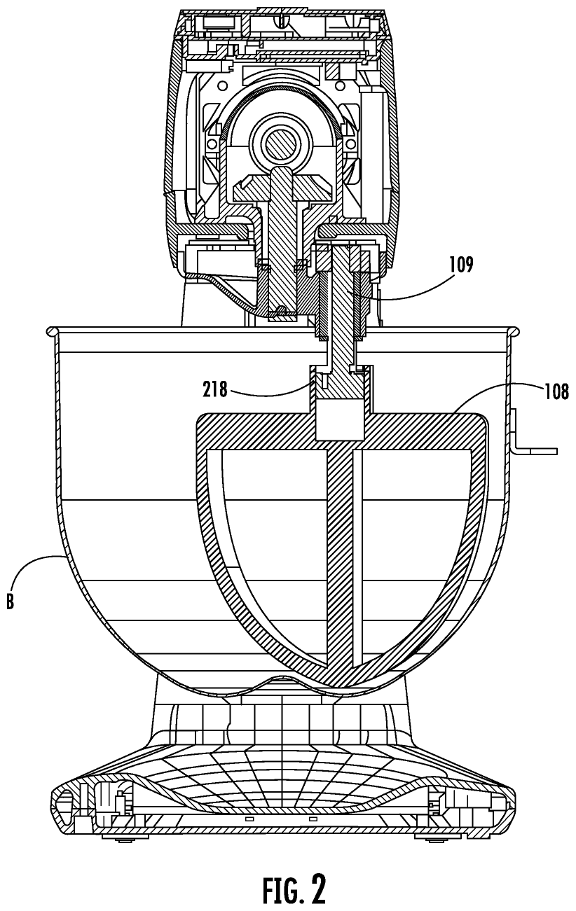

A drivetrain 110 may be provided within motor housing 102 and is configured for coupling motor 112 to a shaft 109 (e.g., a mixer shaft or drive shaft), such that shaft 109 is rotatable via motor 112 through drivetrain 110. Drivetrain 110 may include planetary gearbox 114, bevel gearbox 116, etc. Drive shaft 109 may be positioned above mixing zone 105 on motor housing 102, and an attachment 108, such as a beater, whisk, or hook, may be removably mounted to drive shaft 109. Attachment 108 may rotate within a bowl B (FIG. 2) in mixing zone 105 to beat, whisk, knead, etc. material within the bowl, during operation of motor 112.

As noted above, motor 112 may be operable to rotate drive shaft 109. For instance, a motor shaft 113 may connect motor 112 to drive shaft 109 (e.g., through planetary gearbox 114, bevel gearbox 116, etc.). Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and drive shaft 109.

Stand mixer 100 may include a shaft adjustment assembly 200. Shaft adjustment assembly 200 may be provided at a distal end of drive shaft 109. For instance, shaft adjustment assembly 200 may be operably connected with drive shaft 109. Shaft adjustment assembly 200 may be configured to provide height adjustments (e.g., along the vertical direction V) to attachment 108. For instance, shaft adjustment assembly 200 may allow for incremental height adjustments of attachment 108 relative to drive shaft 109. Shaft adjustment assembly 200 may define an axial direction A, a radial direction R, and a transverse direction T. According to some embodiments, axial direction A may be parallel with vertical direction V of stand mixer 100.

As mentioned, drive shaft 109 may protrude from motor housing 102 toward mixing zone 105. A receptacle (e.g., such as a mixing bowl) B may be selectively positioned within mixing zone. Drive shaft 109 may protrude into receptacle B. Drive shaft 109 may be configured such that attachment 108 is removably coupled thereto. Accordingly, a plurality of attachments may be selectively attached to and detached from drive shaft 109 according to specific desired operations. For instance, attachment 108 may be coupled to drive shaft 109 via shaft adjustment assembly 200. Additionally or alternatively, according to some embodiments, attachment 108 is coupled to drive shaft 109 via one or more additional shafts.

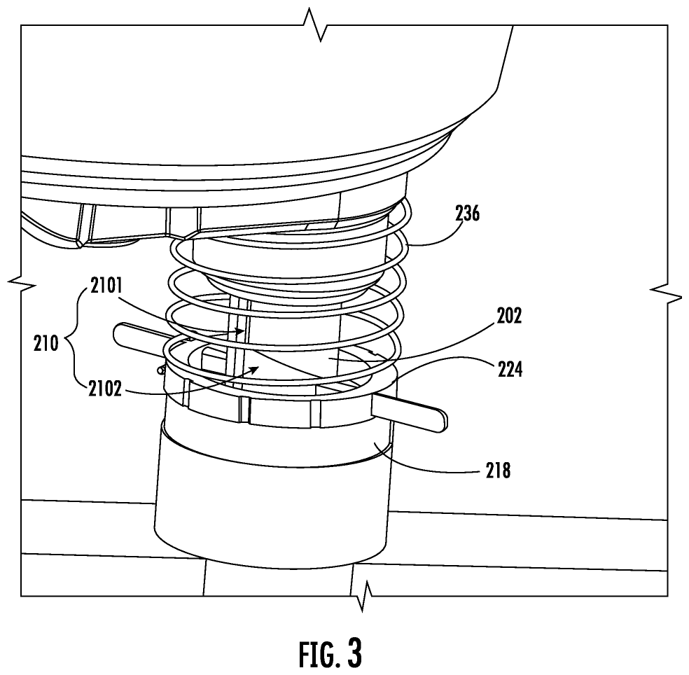

Referring now to FIGS. 3 through 8, shaft adjustment assembly 200 will be described in detail. Shaft adjustment assembly 200 may be operably coupled with motor shaft 113. For instance, shaft adjustment assembly 200 may receive rotational inputs from motor shaft 113 to in turn provide rotation to attachment 108. Shaft adjustment assembly 200 may allow for attachments 108 to be quickly and easily connected to drive shaft 109. Moreover, shaft adjustment assembly 200 may allow for incremental height adjustments to be made to attachment 108 (e.g., with respect to a bottom of receptacle B).

As mentioned above, drive shaft 109 may be connected with attachment 108 via one or more additional shafts. For one example, shaft adjustment assembly 200 includes an output shaft 202. Output shaft may extend along the axial direction A. According to some embodiments, output shaft 202 is operably connected with drive shaft 109. In additional or alternative embodiments, output shaft 202 directly incorporates drive shaft 109 (e.g., such that drive shaft 109 and output shaft 202 are a single piece or item). Output shaft 202 may thus be connected with motor shaft 113 (e.g., either directly or through drive shaft 109). Output shaft 202 may be configured to receive a rotational input from motor shaft 113.

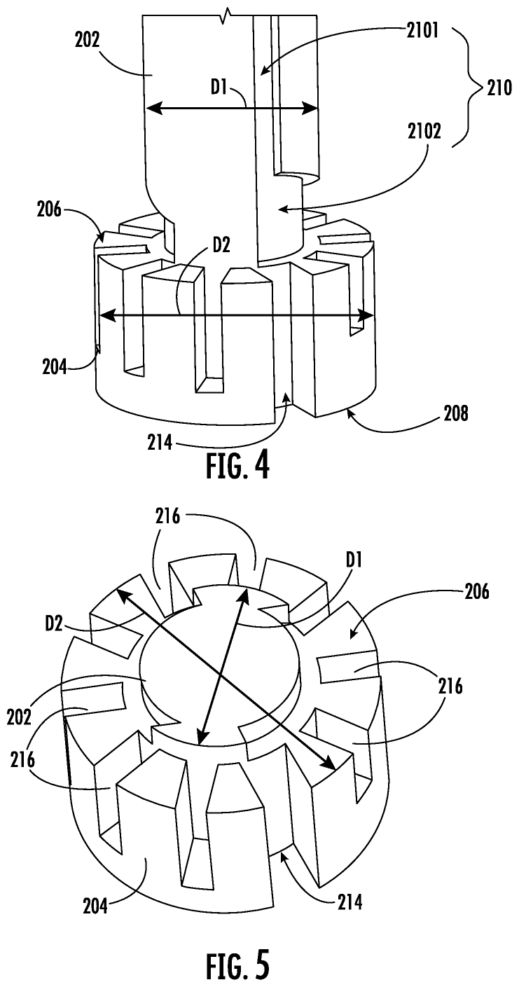

Output shaft 202 may include an attachment holder 204. Attachment holder 204 may be provided at a distal end of output shaft 202 (e.g., along the axial direction A). As seen in FIGS. 4 and 5, output shaft 202 may define a shaft diameter D1. Attachment holder 204 may define a holder diameter D2. Holder diameter D2 may be greater than shaft diameter D1. Accordingly, attachment holder 204 may define a top face 206 and a bottom face 208 opposite top surface 206. Attachment holder 204 may be integrally formed with output shaft 202. For instance, output shaft 202 and attachment holder 204 may be formed as one solid, unitary piece. However, according to some embodiments, attachment holder 204 may be separately coupled to output shaft 202.

Output shaft 202 may include an adjustment groove 210. Adjustment groove 210 may be formed therein (e.g., along the radial direction R). For instance, adjustment groove 210 may protrude into output shaft 202 along the radial direction R, such that a portion of output shaft 202 is removed. Additionally or alternatively, two adjustment grooves 210 may be included (e.g., on opposite sides of output shaft 202). Adjustment groove 210 may protrude a predetermined depth into output shaft 202. For instance, adjustment groove 210 may protrude a predetermined percentage into output shaft 202. The predetermined percentage may be between about 5% and about 20%. As best seen in FIGS. 4 and 7, adjustment groove 210 may include a first portion 2101 and a second portion 2102.

First portion 2101 may extend along the axial direction A from top face 206 of attachment holder 204 toward motor housing 102. For instance, first portion 2101 may extend a predetermined distance along the axial direction A from top face 206. In some embodiments, first portion 2101 defines a terminus after the predetermined distance (i.e., first portion 2101 is a blind groove having a stop before a top of output shaft 202). In additional or alternative embodiments, first portion 2101 extends through the top of output shaft 202. Second portion 2102 may extend along the circumferential direction C from first portion 2101. Second portion 2102 may be positioned at top face 206 of attachment holder 204. For instance, second portion 2102 may extend, as viewed from a top of output shaft 202 along the axial direction A, second portion 2102 may extend along the clockwise direction from first portion 2101. Thus, second portion 2102 may be elongated along the circumferential direction C with respect to first portion 2101.

An extending length of second portion 2102 along the circumferential direction C may vary according to specific embodiments. For one example, second portion 2102 extends for between about 30% and about 45% of a total circumference of output shaft 202. Additionally or alternatively, a top edge 212 of second portion 2102 may be tapered (e.g., along the axial direction A). For instance, with reference to FIG. 7, a height of second portion 2102 along the axial direction A may vary across the circumferential length thereof. A proximal point of top edge 212 may be positioned higher (e.g., further from top face 206) than a distal point of top edge 212. Thus, as second portion 2102 proceeds from first portion 2101 toward its terminus, a height of second portion 2102 decreases along the axial direction A.

Attachment holder 204 may include an inlet channel 214. Inlet channel 214 may extend along the axial direction A from top face 206 to bottom face 208. For instance, inlet channel 214 may be formed into attachment holder 204 along the radial direction R (e.g., as a cut-out). Inlet channel 214 may thus define a through-channel in attachment holder 204. As will be described later, a portion of an attachment adapter (e.g., for attachment 108) may selectively pass through inlet channel 214.

Attachment holder 204 may include a plurality of positioning grooves 216. With reference to FIG. 5, the plurality of positioning grooves 216 may be spaced equidistant about attachment holder 204 along the circumferential direction C. As shown, at least 9 positioning grooves 216 may be included. However, it should be understood that the number of positioning grooves 216 shown is provided by way of example only, and that any suitable number of positioning grooves 216 may be included. Each of the plurality of positioning grooves 216 may extend along the axial direction A from top face 206 of attachment holder 204.

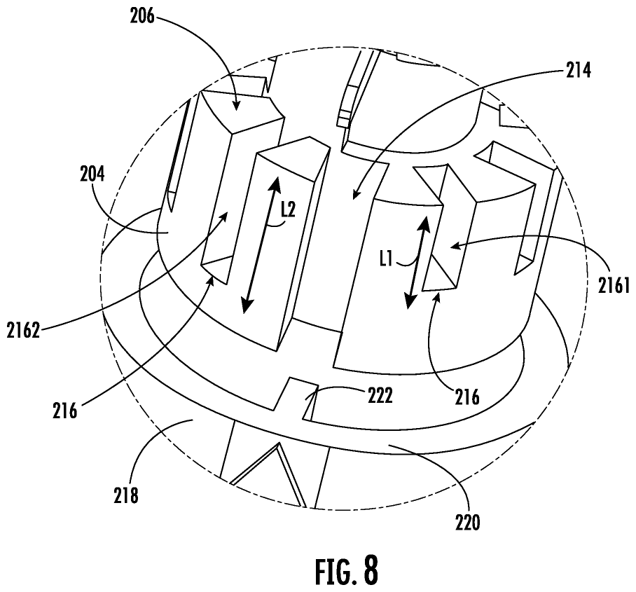

Each of the plurality of positioning grooves 216 may extend to a distinct, unique, and independent depth. As best seen in FIGS. 4, 7, and 8, the depths of each of the plurality of positioning grooves 216 (e.g., along the axial direction A) may vary per individual positioning groove 216. For instance, the plurality of positioning grooves 216 may include a first positioning groove 2161 and a second positioning groove 2162. Referring to FIG. 8, first positioning groove 2161 may define a first length L1 along the axial direction A. First positioning groove 2161 may thus extend from top face 206 for first length L1 to a blind stopping point within attachment holder 204. Similarly, second positioning groove 2162 may define a second length L2 along the axial direction A. Second positioning groove 2162 may thus extend from top face 206 for the second length L2 to a blind stopping point within attachment holder 204. Second length L2 may be different from first length L1. For example, second length L2 is greater than first length L1. Accordingly, the lengths of each of the plurality of positioning grooves 216 may increase incrementally about a circumference of attachment holder 204.

As mentioned above, attachment 108 may include an attachment adapter 218. Attachment adapter 218 may be formed integrally with attachment 108. Additionally or alternatively, attachment adapter 218 may be configured to be selectively coupled to two or more attachments 108 for easy connection with attachment holder 204. Attachment adapter 218 may include a body 220. Body 220 may be annular in shape. For instance, body 220 may be predominantly cylindrical. Body 220 may be configured to slide over attachment holder 204 (e.g., along the axial direction A). Thus, a diameter of body 220 may be greater than holder diameter D2 of attachment holder 204.

Attachment adapter 218 may include a tab 222. Tab 222 may protrude from an inner circumferential surface of body 220. A protrusion distance or length of tab 222 may be less than or equal to the predetermined depth of inlet channel 214. As shown in FIG. 8, tab 222 may be aligned with inlet channel 214 along the axial direction A. In order to attach attachment 108 (e.g., attachment adapter 218) to output shaft 202, body 220 may be slid over attachment holder 204 (e.g., along the axial direction A) when tab 222 is aligned with inlet channel 214. Since inlet channel 214 is defined through an entirety of attachment holder 204, tab 222 may pass through to be positioned above top face 206 thereof. At this point, attachment adapter 218 may be rotated (e.g., clockwise, counterclockwise). Tab 222 may then be positioned within a selected positioning groove 218. For instance, a user may select a height at which they desire to have attachment 108 be (e.g., with respect to a bottom of bowl B) and then select the corresponding positioning groove 218. Since each of the plurality of positioning grooves 218 has a different depth (e.g., along the axial direction A), attachment 108 may be positioned at a different height according to whichever positioning groove 216 receives tab 222 therein.

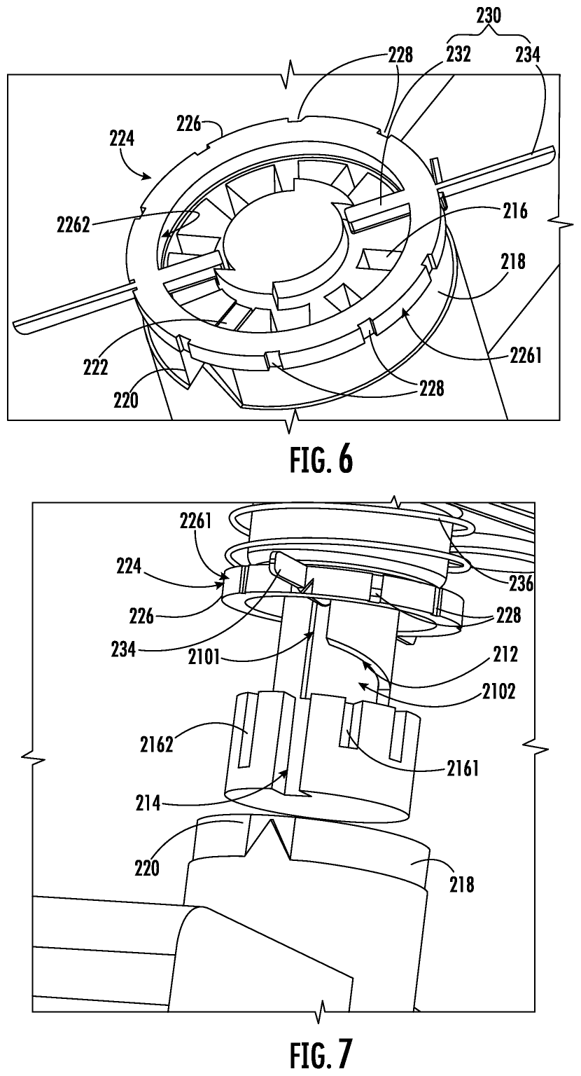

Shaft adjustment assembly 200 may include a handle 224. Handle 224 may be adjustable coupled with output shaft 202. For instance, handle 224 may be rotatable about the circumferential direction C with respect to output shaft 202. Thus, handle 224 may be positioned around output shaft 202 (e.g., along the radial direction R). Handle 224 may include a main annular body 226. As mentioned, main annular body 226 may surround output shaft 202. Main annular body 226 may include a plurality of indicators 228. Referring briefly to FIGS. 6 and 7, the plurality of indicators 228 may be provided along an outer circumferential surface 2261 of main annular body 226. The plurality of indicators 228 may be spaced equidistant about outer circumferential surface 2261 of main annular body 226. For instance, the plurality of indicators may correspond to the plurality of positioning grooves 216. Each of the plurality of indictors 228 may indicate the height of the corresponding positioning groove 216. Accordingly, a user may easily determine and select the desired height of attachment 108.

Handle 224 may include at least one arm 230. Arm 230 may extend from main annular body 226 along the radial direction R. In detail, arm 230 may include a first section 232 and a second section 234. First section 232 may extend inward (e.g., along the radial direction R) from an inner circumferential surface 2262 of main annular body 226. Thus, first section 232 may extend toward output shaft 202. An extending length of first section 232 may be greater than a recessed depth (e.g., along the radial direction R) of the plurality of positioning grooves 216. For instance, first section 232 may be at least partially received within adjustment groove 210. As mentioned above, two adjustment grooves 210 may be provided on output shaft 210. Accordingly, two arms 230 may be included on handle 224. Thus, a first handle may be received within a first adjustment groove and a second handle may be received within a second adjustment groove.

Arm 230 (e.g., first section 232) may be configured to move within adjustment groove 210. For instance, first section 232 may move along the circumferential direction C within second portion 2102 of positioning groove 210 and may move along the axial direction A within first portion 2101 of positioning groove 210. Thus, handle 224 may rotate (e.g., about the circumferential direction C) and translate (e.g., about the axial direction A). Handle 224 may be movable between a first position (FIG. 3) and a second position (FIG. 7). When handle 224 is in the first position, attachment adapter 218 is locked into place within the selected positioning groove 216. When handle is moved to the second position, attachment adapter 218 is able to move upward along the axial direction A and rotated about the circumferential direction C. Thus, a user may switch a position of attachment adapter 218 and thus switch a height of attachment 108.

Second section 234 may extend outward (e.g., along the radial direction R) from outer circumferential surface 2261 of main annular body 226. Second section 234 may be configured such that a user may grasp second section 234 to provide a rotational force thereto. An extending length of second section 234 (e.g., along the radial direction R) may be greater than the extending length of first section 232. However, it should be understood that second section 234 may extend to any suitable length, and the disclosure is not limited to the examples provided herein.

Shaft adjustment assembly 200 may include a resilient member 236. Resilient member 236 may connect handle 224 with output shaft 202. For instance, resilient member 236 may be a spring configured to provide each of a rotational force and an axial force to handle 224 with respect to output shaft 202. In some embodiments, resilient member 236 is a coil spring. Resilient member 236 may be positioned circumferentially around output shaft 202. Additionally or alternatively, resilient member 236 may be connected to output shaft 202 through one or more separate pieces, such as clamps, clips, collars, or the like.

Resilient member 236 may bias handle 224 along the circumferential direction C. For instance, resilient member 236 may maintain first section 232 of arm 230 in a locked position (e.g., within second portion 2102 of adjustment groove 210). A user may apply a force to second section 234 of arm 230 to counter the biasing force of resilient member 236 and move handle 224 from the first position to the second position. Moreover, resilient member 236 may bias handle 224 downward along the axial direction A (e.g., into the first position). Accordingly, attachment adapter 218 may be locked into place to restrict attachment 108 from inadvertently adjusting during operation.

According to the embodiments described herein, accessories for a stand mixer may be fine adjusted along the axial direction through a handle, an accessory holder, and a plurality of individually heighted positioning grooves. The accessory may include an accessory adapter having a tab. The tab may be selectively placed into one of the plurality of positioning grooves according to the desired height. A handle may be biased via a resilient member to hold the accessory adapter in a locked position within the selected positioning groove. Advantageously, users may easily attach the attachment to the output shaft, select a desired mixing height, and lock the attachment in place by twisting the handle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer comprising:
a casing comprising a base, a column extending from the base, and a motor housing connected to the column;
a motor assembly provided within the motor housing, the motor assembly comprising a motor shaft; and
a shaft adjustment assembly operably coupled with the motor shaft, the shaft adjustment assembly defining an axial direction, a radial direction, and a circumferential direction, the shaft adjustment assembly comprising:
an output shaft connected with the motor shaft, the output shaft configured to receive a rotational input from the motor shaft, the output shaft comprising an attachment holder at a distal end thereof;
a handle adjustably coupled with the output shaft, the handle being configured to be rotatable about the circumferential direction; and
a resilient member connecting the handle with the output shaft, the resilient member biasing the handle along the axial direction and along the circumferential direction.

2. The stand mixer of claim 1, wherein a diameter of the attachment holder is greater than a diameter of the output shaft.

3. The stand mixer of claim 2, wherein the attachment holder comprises:
an inlet channel extending along the axial direction from a top face to a bottom face of the attachment holder, the inlet channel being formed into the attachment holder along the radial direction; and
a plurality of positioning grooves extending along the axial direction from the top face of the attachment holder to a plurality of predetermined depths.

4. The stand mixer of claim 3, wherein each of the plurality of positioning grooves is spaced equidistant about the attachment holder along the circumferential direction.

5. The stand mixer of claim 3, wherein the plurality of positioning grooves comprises:
a first positioning groove defining a first length along the axial direction; and
a second positioning groove defining a second length along the axial direction, the second length being different from the first length.

6. The stand mixer of claim 3, wherein the handle comprises:
a main annular body; and
at least one arm extending from the main annular body along the radial direction, the at least one arm comprising a first section extending inward from the main annular body and a second section extending outward from the main annular body.

7. The stand mixer of claim 6, wherein the output shaft comprises an adjustment groove formed therein, the adjustment groove comprising:
a first portion extending along the axial direction from the top face of the attachment holder toward the motor housing; and
a second portion extending along the circumferential direction from the first portion at the top face of the attachment holder.

8. The stand mixer of claim 7, wherein the first section of the at least one arm is at least partially positioned within the adjustment groove.

9. The stand mixer of claim 7, wherein the resilient member biases the first section of the at least one arm from the first portion into the second portion of the adjustment groove.

10. The stand mixer of claim 6, wherein the main annular body comprises a plurality of indicators provided on an outer surface of the main annular body, the plurality of indicators corresponding to the plurality of positioning grooves.

11. A shaft adjustment assembly for a domestic appliance, the domestic appliance comprising a motor assembly and a motor shaft, the shaft adjustment assembly defining an axial direction, a radial direction, and a circumferential direction, the shaft adjustment assembly comprising:
an output shaft connected with the motor shaft, the output shaft configured to receive a rotational input from the motor shaft, the output shaft comprising an attachment holder at a distal end thereof;
a handle adjustably coupled with the output shaft, the handle being configured to be rotatable about the circumferential direction; and
a resilient member connecting the handle with the output shaft, the resilient member biasing the handle along the axial direction and along the circumferential direction.

12. The shaft adjustment assembly of claim 11, wherein a diameter of the attachment holder is greater than a diameter of the output shaft.

13. The shaft adjustment assembly of claim 12, wherein the attachment holder comprises:
an inlet channel extending along the axial direction from a top face to a bottom face of the attachment holder, the inlet channel being formed into the attachment holder along the radial direction; and
a plurality of positioning grooves extending along the axial direction from the top face of the attachment holder to a plurality of predetermined depths.

14. The shaft adjustment assembly of claim 13, wherein each of the plurality of positioning grooves is spaced equidistant about the attachment holder along the circumferential direction.

15. The shaft adjustment assembly of claim 13, wherein the plurality of positioning grooves comprises:
a first positioning groove defining a first length along the axial direction; and
a second positioning groove defining a second length along the axial direction, the second length being different from the first length.

16. The shaft adjustment assembly of claim 13, wherein the handle comprises:
a main annular body; and
at least one arm extending from the main annular body along the radial direction, the at least one arm comprising a first section extending inward from the main annular body and a second section extending outward from the main annular body.

17. The shaft adjustment assembly of claim 16, wherein the output shaft comprises an adjustment groove formed therein, the adjustment groove comprising:
a first portion extending along the axial direction from the top face of the attachment holder toward the motor housing; and
a second portion extending along the circumferential direction from the first portion at the top face of the attachment holder.

18. The shaft adjustment assembly of claim 17, wherein the first section of the at least one arm is at least partially positioned within the adjustment groove.

19. The shaft adjustment assembly of claim 17, wherein the resilient member biases the first section of the at least one arm from the first portion into the second portion of the adjustment groove.

20. The shaft adjustment assembly of claim 16, wherein the main annular body comprises a plurality of indicators provided on an outer surface of the main annular body, the plurality of indicators corresponding to the plurality of positioning grooves.
